(19) United States
(12) Patent Application Publication
(10) Pub. No.: US 2019/0211613 A1
(43) Pub. Date: Jul. 11, 2019

(54) INSULATING GLASS UNIT

(71) Applicant: DOW SILICONES CORPORATION, Midland, MI (US)

(72) Inventor: Dominique CULOT, Seneffe (BE)

(21) Appl. No.: 16/333,344

(22) PCT Filed: Sep. 15, 2017
(86) PCT No.: PCT/EP2017/073353

§ 371 Date: Mar. 14, 2019

(30) Foreign Application Priority Data
Sep. 17, 2016 (GB) 1615907.1

(51) Int. Cl. E06B 3/663; E06B 3/673; E06B 3/677; C03C 17/30

(52) U.S. Cl. CPC E06B 3/66333; E06B 3/66328; E06B 3/6733; E06B 2003/66338; E06B 3/66342; C03C 17/30; E06B 3/6775

(57) ABSTRACT

An insulating glass unit is provided. The insulating glass unit comprises two glass panes spaced apart by a transparent spacer material adherent to the glass panes, e.g. a silicone hot melt material. Optionally, an inert or heavy gas is trapped within the unit. The insulating glass unit further comprises a layer of a transparent silicone elastomer located at the periphery of the unit between edge portions of the glass panes and in contact with external surfaces of the spacer. Processes for making the insulating glass unit are also described herein.

This invention is concerned with improvements in or relating to insulating glass units.

It has been a practice for many years to form insulating glass units consisting of two, three, or more glass panes which are spaced apart by a spacing and sealing assembly (generally referred to as “edge seal”) extending around the periphery of the inner facing surfaces of the glass panes to define a substantially hermetically sealed insulating space between adjacent glass panes. It is a common practice to employ a spacer to separate the glass panes and to assure the required rigidity of the unit. The spacer may self-adhere to the glass or may be adhered to the glass using a so-called primary sealant e.g. a “butyl sealant” which is a polyisobutylene rubber based composition as primary sealant to bond the metal spacer to the glass panes. A secondary sealant is then employed to seal the gap defined by the spacer and the periphery of the panes. A gas other than air, for example an inert gas such as argon, xenon, krypton or SF₆ may be introduced into the insulating glazing unit with a view to improving the level of thermal or acoustic performances required. In a glazing unit as described, the primary sealant ensures satisfactory adhesion of the spacer to the glass panes so as to provide desired moisture vapour and/or gas impermeability to the unit, thus avoiding moisture vapour entering and condensing in the cavity of the unit and, in case of a gas filled unit avoiding escape of gas from the unit and the secondary sealant serves to promote the integrity of the bond of the self-adhered spacer or primary sealant by minimising the strain imposed on it due to external factors such as fluctuations in ambient temperature, barometric pressure, or wind pressure.

A wide variety of spacers have been proposed, for example, the insulating glass unit can comprise glass sheets (panes) which are held apart and adhered to one another by a self-adhering thermoplastic spacer. During assembly of such a unit, the spacer is applied as a strand, for example by extrusion, onto a first of the two glass panes along its edge. The beginning and the end of the strand are joined. The glass panes are then assembled and pressed together to a predetermined distance apart, equal to the width that the spacer is to have in the insulating glass unit, so that the strand of thermoplastic material is pressed against the glass panes and bonds the panes together.

Other spacers used include foamed plastics materials, for example a silicone foam or a polyolefin foam such as an ethylene propylene diene terpolymer foam, a mastic, for example a polyisobutylene mastic, containing a reinforcement which helps to keep the glass sheets the required distance apart when an insulating glass unit is assembled, or a hollow section for example an aluminium or stainless steel section or a hollow section of rigid plastics material, generally containing a desiccant. Typically such spacers are used in conjunction with a primary sealant to adhere the spacer to the glass and a secondary sealant layer, for example a layer of silicone elastomer, polyurethane, polysulfide, butyl hot melt or polyurethane reactive hot melt located at the periphery of the insulating glass unit between the edge portions of the glass panes, such that the layer of sealant is in contact with external surface of the reinforced mastic. For example, in one typical form of insulating glass unit construction, the edge seal comprises a hollow metal spacer element adhered to the inner facing surfaces of the glass panes by a low gas and moisture permeable sealant to provide a primary hermetic seal. The hollow spacer element is filled with a desiccant material, which is put in communication with the insulating space between the glass panes to absorb moisture therefrom in order to improve the performance and durability of the insulating glass unit.

Various materials have been used to provide the secondary sealant, as mentioned above. However, the vast majority of commercially available materials for use as primary and/or secondary sealants are black or white or another colour and non-transparent, thereby reducing the area of the insulating glass unit through which light may pass.

As mentioned above, thermal transfer by conduction or convection can be decreased by substituting or partially substituting air present in the cavity of the insulating glass unit with a heavy rare gas having a lower thermal conductivity for example an inert gas such as argon, xenon, krypton or SF₆. Transfer by radiation can be decreased using low-emissivity (low E) glass. Typically, the thermal coefficient (the so-called “K-value”, which is a measure of the flux of heat energy through an area of 1 m² in the centre of the insulating glass unit for a temperature difference of 1° K between the interior and exterior) for high performance insulating glass units filled with gas is below 1.5 and can be as low as 1.2, some combinations of low E coatings and special gases allowing K-values below 1.0 W/m²/K (i.e. Watts per square meter per degree Kelvin). For acoustic performance, beside the use of glass pane elements with different thickness e.g. in combination with laminated glass, a better acoustic performance can also be achieved by replacing a part or all of the air or rare gas present in the cavity by SF₆ gas.

Although desirably low K-values can be obtained with special gas fillings and low E-coatings in the center of the insulating glass unit, the use of conventional edge seal systems, containing a metal spacer, results in higher thermal conductivity at the perimeter of the insulating glass unit. The higher conductivity of the edge seal causes water condensation to occur on the interior glass surface under certain environmental conditions and is therefore undesirable. Several technical solutions have been proposed regarding edge seals with reduced thermal conductivity (so-called “warm edge” systems).

However, one disadvantage of such edge seals for glazing units is that they are generally coloured, e.g. black and non-transparent and as such reduce the viewing area of a person looking through the window. It is the aim herein to maximise the viewing area by providing a transparent edge seal.

It is an object herein to provide an insulating glass unit with a transparent edge-seal to enlarge the viewing region of the insulated glass unit.

The present invention provides in one of its aspects an insulating glass unit comprising two glass panes spaced apart by a transparent spacer material adherent to the panes, optionally having an inert or heavy gas trapped within the unit and a layer of a transparent silicone elastomer located at the periphery of the unit between edge portions of the glass panes and in contact with external surfaces of the spacer.

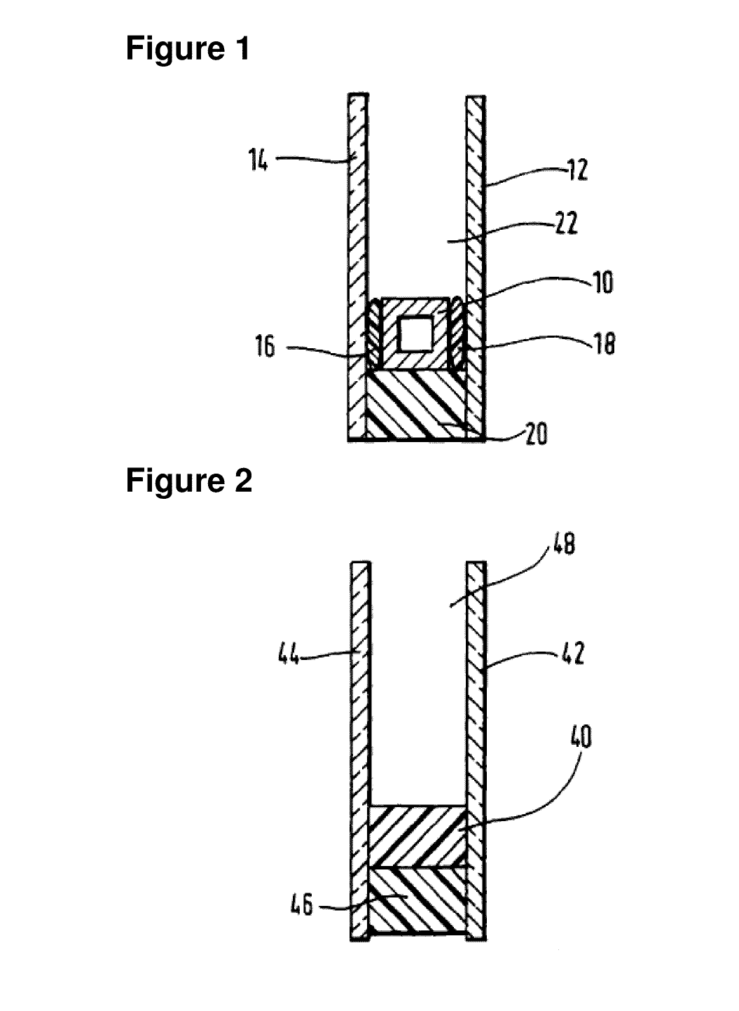

The spacer may be selected from any suitable transparent material. Examples include, glass, a hydrosilylation or peroxide cured silicone rubber elastomer, polycarbonate, clear butyl rubber, polymethylmethacrylate (PMMA), and extruded transparent polyisobutylene (FIB) and the like. The spacer may have any suitable cross-sectional geometry, it may be a pre-cured strip of material adhered to the glass surface via a primary sealant, or may be self-adhesive to the glass surface or may be a pre-shaped solid e.g. of glass for example a pre-formed frame (e.g. FIG. 1 herein), providing in each case that the spacer is transparent. The spacer may be either self-adhesive to the substrate, e.g. adhered directly to the surface of the glass panes of an insulated glazing unit or may be adhered to the glass using a transparent primary sealant.

In an insulating glass unit according to the present invention, the spacer element may be, for example, a transparent thermoplastic material based on polyisobutylene, which may contain desiccant. Suitable materials are those which can be extruded as a hot melt, and cool to a solid mass adherent to the glass. If desired, the material may undergo a measure of curing after application as a hot melt.

The silicone elastomer as hereinbefore described is preferably the cured elastomeric product of a moisture-curable hot melt silicone adhesive composition. Preferably moisture-curable hot melt silicone adhesive composition comprises:
(A) a reactive resin comprising the reaction product of a reaction of:
   (i) an alkenyl-functional siloxane resin comprising R₃SiO_{1/2} units and SiO_{/22} units, wherein each R is independently a monovalent hydrocarbon radical having 1 to 6 carbon atoms with the proviso that at least one R is an alkenyl radical, wherein the molar ratio of the R₃SiO_{1/2} units to SiO_{4/2} units has a value of from 0.5/1 to 1.5/1,
   (ii) an alkoxysilane-functional organosiloxane compound having at least one silicon-bonded hydrogen atom, and optionally
   (iii) an endcapper and optionally
   (iv) an alkenyltrialkoxysilane, in the presence of a
   (v) hydrosilylation catalyst,
(B) a reactive polymer comprising the reaction product of a reaction of:
   (vi) an alkoxysilane-functional organosiloxane compound having at least one silicon-bonded hydrogen atom; and
   (vii) a polyorganosiloxane having an average, per molecule, of at least 2 aliphatically unsaturated organic groups, optionally
   (viii) an alkenyltrialkoxysilane, in the presence of
   (ix) a hydrosilylation catalyst;
(C) a moisture cure catalyst; and
(D) a crosslinker.

As noted above, the reactive resin (A) is formed as the reaction product of a reaction of (i) an alkenyl-functional siloxane resin, (ii) an alkoxysilane-functional organosiloxane compound having at least one silicon-bonded hydrogen atom, and optionally (iii) an endcapper and (iv) vinyltrimethoxysilane in the presence of (iv) a hydrosilylation catalyst.

In certain embodiments, the reactive resin (A) has a weight average molecular weight M_{w} ranging from 12,000 to 30,000 g/mole (Daltons), alternatively from 17,000 and 22,000 g/mole. In addition, it is preferable that the hydroxyl content of the reactive resin (A) is less than 1 weight percent of the total weight of reactive resin (A). The term “hydroxyl content”, as defined herein, refers to the weight percent of hydroxyl groups in the particular molecule in which they are included, and here defined as the total weight percent of hydroxyl groups in the reactive resin (A) (i.e., the weight percent of OH groups in the reactive resin (A)).

Component (i) of the reactive resin (A) is an alkenyl-functional siloxane resin comprising R₃SiO_{1/2} units and SiO_{4/2} units (i.e., M and Q Units). At least one third, and more preferably substantially all R radicals, are methyl radicals, with the proviso that at least one R radical is an alkenyl radical, and further with the proviso that the resin (i) ranges from 0.6 to 2.2 weight percent, alternatively from 1.0 to 2.0 weight percent, alkenyl-functionality, based on the total weight of the resin (i). Stated differently, the alkenyl radical content of the resin (i) ranges from 0.6 to 2.2 weight percent, alternatively from 1.0 to 2.02 weight percent, of the total weight of the resin (i). Also, the component (i) has a silanol content of less than 1.0 weight percent, alternatively 0.3 to 0.8 weight percent, based on the total weight of the reactive resin (A). Examples of preferred R₃SiO_{1/2} units having methyl radicals include Me₃SiO_{1/2} units and PhMe₂SiO_{1/2} units, wherein Me is methyl and Ph is phenyl. The term “silanol content”, as defined herein, refers to the weight percent of silicon-hydroxy groups in the particular molecule in which they are included, and here defined as the total weight percent of silicon-hydroxy groups in the component (i) (i.e., the weight percent of Si—OH groups in the resin).

For the purposes of the present invention, the molar ratio of R₃SiO_{1/2} units to SiO_{4/2} units in resin (i) ranges from 0.5:1 to 1.5:1. Alternatively, the molar ratio of the total M units to total 0 units of the resin (i) is between 0.6:1 and 1.0:1. The above M/Q molar ratios can be easily obtained by ²⁹Si nuclear magnetic resonance (NMR) spectroscopy.

In addition, the resin (i) has a weight average molecular weight Mw ranging from 12,000 to 30,000 g/mole (Daltons), alternatively from 17,000 and 22,000 g/mole.

In certain embodiments, the resin (i) comprises from 82 to 99 weight percent, alternatively from 85 to 98 weight percent, of the total weight of the reactive resin (A).

Component (ii) of component (A) is an alkoxysilane-functional organosiloxane compound having at least one silicon-bonded hydrogen atom at a molecular terminal. In certain embodiments, the compound (ii) is of the general formula HSi(R²)₂OSi(R²)₂CH₂CH₂SiR²_{z}(OR²)_{3-z}, wherein R² is a monovalent hydrocarbon having 1 to 6 carbon atoms and wherein the subscript z is 0 or 1. Even more preferably, the alkoxysilane-functional organosiloxane compound having at least one silicon-bonded hydrogen atom at a molecular terminal (ii) is of the general formula HSi(Me)₂OSi(Me)₂CH₂CH₂Si(OMe)₃, wherein Me is methyl.

In certain embodiments, the compound (ii) comprises from 1 to 8 weight percent, alternatively from 2 to 7 weight percent, of the total weight of the reactive resin (A).

In certain embodiments, the reactive resin (A) includes, as part of its reaction product, an endcapper (iii). The endcapper (iii) may be a polydiorganosiloxane having one hydrogen atom per molecule. An exemplary endcapper may have the formula (I), formula (II), or a combination thereof. Formula (I) is R³₃Si—(R³₂SiO)ₛ—SiR³₂H. Each R³ is independently a monovalent hydrocarbon group exemplified by alkyl such as methyl, ethyl, propyl, butyl, pentyl, and hexyl; and aryl such as phenyl, tolyl, xylyl and benzyl; and subscript s has a value ranging from 0 to 10, alternatively 1 to 10, and alternatively 1. Formula (II) is R⁴₃Si—(R⁴₂SiO)₆—(HR⁴SiO)—SiR⁴₃. In this formula, each R⁴ is independently a monovalent hydrocarbon group exemplified by alkyl such as methyl, ethyl, propyl, butyl, pentyl, and hexyl; and aryl such as phenyl, tolyl, xylyl and benzyl. Subscript t has a value ranging from 0 to 10, alternatively 0.

In certain embodiments, the endcapper (iii) comprises up to 9 weight percent, alternatively up to 8 weight percent, of the total weight of the reactive resin (A).

In certain embodiments, the reactive resin (A) includes, as part of its reaction product, (iv) a alkenyltrialkoxysilane according to the formula AlkSi(OR⁵)₃, wherein each R⁵ is independently a monovalent hydrocarbon having 1 to 6 carbon atoms, wherein Alk represents an alkenyl group having 2 to 6 carbon atoms, and wherein the alkenyl group is at the molecular terminal. Exemplary alkenyltrialkoxysilanes include vinyltrimethoxysilane, allyltrimethoxysilane and hexenyltrimethoxysilane.

In certain embodiments, the alkenyltrialkoxysilane (iv) comprises up to 1 weight percent, alternatively from 0.05 to 0.3 weight percent, of the total weight of the reactive resin (A).

The weight percent of silicon bonded hydrogen atoms in the components/unsaturated organic groups capable of undergoing hydrosilylation in the components (commonly referred to as SiHₜₒₜ/Viₜₒₜ ratio) of the reactive resin (A) may range from 0.1 to 1.0. In this ratio, SiHₜₒₜ refers to the total amount of silicon bonded hydrogen atoms in component (ii) in combination with the amount of silicon bonded hydrogen atoms in component (iii), if present. Viₜₒₜ refers to the total amount of aliphatically unsaturated organic groups in component (i) in combination with the amount of aliphatically unsaturated organic groups in component (iv), if present.

Component (v) of the reactive resin (A) is a hydrosilylation catalyst which accelerates the reaction of components (i)-(ii), as well as optional components (iii) and (iv), if present. Component (v) may be added in an amount sufficient to promote the reaction of components (i)-(ii), as well as optional components (iii) and (iv), if present, and this amount may be, for example, sufficient to provide 0.1 parts per million (ppm) to 1000 ppm of platinum group metal, alternatively 1 ppm to 500 ppm, alternatively 2 ppm to 200, alternatively 5 ppm to 20 ppm, based on the combined weight of components (i)-(ii) and optionally (iii) and (iv) used in the process. Alternatively, component (v) may be from 0.05 to 0.3 weight percent, alternatively from 0.05 to 0.15 weight percent, of the total weight of the reactive resin (A).

Suitable hydrosilylation catalysts are known in the art and commercially available. Component (v) may comprise a platinum group metal selected from platinum (Pt), rhodium, ruthenium, palladium, osmium or iridium metal or organometallic compound thereof, or a combination thereof. Component (v) is exemplified by compounds such as chloroplatinic acid, chloroplatinic acid hexahydrate, platinum dichloride, and complexes of the compounds with low molecular weight organopolysiloxanes or platinum compounds microencapsulated in a matrix or coreshell type structure. Complexes of platinum with low molecular weight organopolysiloxanes include 1,3-diethenyl-1,1,3,3-tetramethyldisiloxane complexes with platinum. Alternatively, the catalyst may comprise 1,3-diethenyl-1,1,3,3-tetramethyldisiloxane complex with platinum. When the catalyst is a platinum complex with a low molecular weight organopolysiloxane, the amount of catalyst may range from 0.04% to 0.4% based on the combined weight of the components used in the process.

Suitable hydrosilylation catalysts for component) are described in, for example, U.S. Pat. Nos. 3,159,601; 3,220,972; 3,296,291; 3,419,593; 3,516,946; 3,814,730; 3,989,668; 4,784,879; 5,036,117; and 5,175,325 and EP 0 347 895 B.

The moisture cure catalyst (C), which is used to accelerate the cure of the instant compositions upon exposure to moisture, may be selected from those compounds known in the art to promote the hydrolysis and subsequent condensation of hydrolyzable groups, in particular alkoxy groups. Suitable curing catalysts include, but are not limited to, metal salts of carboxylic acids, such as dibutyltin dilaurate and dibutyltin diacetate, stannous octanoate, ferrous octanoate, zinc naphthenate, zinc octanoate, lead 2-ethylhexanoate; organotitanium compounds such as tetrabutyl titanate and 2,5-di-isopropoxy-bis(ethylacetate)titanium; and partially chelated derivatives of these salts with chelating agents such as acetoacetic acid esters and beta-diketones.

A sufficient quantity of moisture cure catalyst (C) is added to accelerate the cure of the hot melt adhesive composition. This amount can readily be determined by the skilled artisan through routine experimentation and is typically about 0.01 to 3 weight percent, alternatively from 0.1 to 1.0 weight percent, based on the combined weight of the resin (A) and polymer (B) solids.

The crosslinker (D) of the present invention is typically a silane represented by monomers of the formula R¹⁰_{4-y}SiX_{y} and oligomeric reaction products thereof; wherein R¹⁰ is selected from the group consisting of hydrocarbon radicals and substituted hydrocarbon radicals having 1 to 6 carbon atoms. X in the above formula is a hydrolyzable group, preferably selected from alkoxy radicals having 1 to 4 carbon atoms, ketoxime radicals, aminoxy radicals, acetamido, N-methylacetamido or acetoxy radicals and y is 2 to 4, preferably 3 to 4. The ketoxime groups are of the general formula —ONC(R¹¹)₂, in which each R¹¹ independently represents an alkyl radical having 1 to 6 carbon atoms or a phenyl radical.

Specific examples of silanes include, but are not limited to, methyltriethoxysilane, ethyltrimethoxysilane, propyltrimethoxysilane, tetramethoxysilane tetraethoxysilane, phenyltrimethoxysilane, isobutyltrimethoxysilane, and 3-mercaptopropyltrimethoxysilane, (1,6-Bis(trimethoxysilyl)hexane)glycidoxypropyltrimethoxysilane, aminoethylaminopropyltrimethoxysilane, methyltriacetoxysilane, ethyltriacetoxysilane, tetra(methylethyl ketoximo)silane, methyl-tris(methylethylketoximo)silane and vinyl-tris(methylethylketoximo)silane, and others.

Typically the crosslinker (D) is added in amounts ranging from 0.01 to 10 weight percent, alternatively from 0.3 to 5 weight percent, based on the weight of (A) and (B). The silane may be added for several purposes including, but not limited to, to provide stability to the compositions as a moisture scavenger, to aid with network formation, and to act as an adhesion promoter.

Hot melt adhesive compositions of the present invention can be obtained when the weight ratio of reactive resin (A) to reactive polymer (B) ranges from 40:60 to 80:20, alternatively from 50:50 to 70:30, alternatively from 55:45 to 65:35, based on solids. The precise ratio needed to form these systems can be ascertained for a given resin and polymer combination by routine experimentation based on the instant disclosure. When this ratio is below about 40:60, the compositions are fluids which do not exhibit non-slump character; when this ratio is above about 80:20, the compositions exhibit an increased tendency to produce embrittled materials upon cure (i.e., they do not form elastomers).

By “non-slump” it is meant that the material appears to be a solid such that, when a 60 cc jar is filled to about one third capacity with the material and tipped on its side at room temperature (i.e., about 25° C.), essentially no flow is observed within a 20 minute period. This corresponds to a minimum room temperature dynamic viscosity in the approximate range 2×10⁷ to 8×10⁷ mPas when measured at 1 radian/sec. The hot melt compositions of the invention flow at elevated temperatures and can readily be extruded from a conventional hot melt gun (e.g., the dynamic viscosity is of the order 10⁴ mPas at 200° C.).

In addition to components (A)-(D) provided above, in general, small amounts of additional components may be added to the hot melt adhesive composition as hereinbefore described provided the resulting elastomer, when cured, is transparent. For example, one or more fillers (E), corrosion inhibitors (F), thermal stabilizers (G), rheological aids (H), and others, may be added as long as they do not materially alter the requirements stipulated herein.

The filler (E) may be added in an amount up to 60 weight percent, alternatively 30 to 55 weight percent, of the total weight of the hot melt adhesive composition. Fillers (E) useful in the instant invention may be exemplified by, but not limited to, inorganic materials such as pyrogenic silica, precipitated silica and diatomaceous silica, ground quartz, aluminum silicates, mixed aluminum and magnesium silicates, zirconium silicate, mica powder, calcium carbonate, glass powder and fibres, titanium oxides of the pyrogenic oxide and rutile type, barium zirconate, barium sulphate, barium metaborate, boron nitride, lithopone, the oxides of iron, zinc, chrome, zirconium, and magnesium, the different forms of alumina (hydrated or anhydrous), and calcined clay and organic materials such as the phthalocyaniines, synthetic fibres and synthetic polymers (polytetrafluoroethylene, polyethylene, polypropylene, polystyrene and polyvinyl chloride). The filler (E) may be of a single type or mixtures of several types.

Component (F) is a corrosion inhibitor. Examples of suitable corrosion inhibitors include benzotriazole, mercaptabenzotriazole, mercaptobenzothiazole, and commercially available corrosion inhibitors such as 2,5-dimercapto-1,3,4-thiadiazole derivative (CUVAN® 826) and alkylthiadiazole (CUVAN® 484) from R. T. Vanderbilt. The amount of component (F) may range from 0.05% to 0.5% based on the weight of the hot melt adhesive composition.

Component (G) is a thermal stabilizer. Suitable thermal stabilizers that may be utilized include Ce, Cu, Zr, Mg, Fe and Zn metal salts. The amount of component (G) may range from 0.001% to 1.0% based on the weight of the hot melt adhesive composition. Component (H) is a rheological aid that, in certain embodiments, may function to modify the melt viscosity and/or to improve the green strength for the hot melt compositions. Suitable rheological aids include, but are not limited to, plasticizers, nonreactive waxes, reactive waxes, tackifier resins, and combinations thereof.

Suitable examples of component (H) include but are not restricted to one or more of the following, and their derivatives: polyolefins such as polyethylenes, polypropylenes, polybutylenes, and polyisobutylenes; polyvinyl acetate; hydrocarbon resins, hydrogenated aromoatic pure monomer hydrocarbon resins, including aromatic pure styrene hydrocarbon resins; asphalts; bitumens; paraffins; crude rubbers; fluorinated rubbers; fluorocarbons; polystyrenes; cellulosic resins; acrylic resins; styrene butadiene resins; polyterpenes; ethylene propylene diene monomer (EPDM); and mixtures and/or derivatives thereof.

Suitable commercial materials that may be utilized include Benzoflex 352, available from Eastman Chemical Co. of Kingsport, Tenn.; Vorasil 602 or 604, each available from Dow Chemical of Midland, Mich.; Licocene® PE SI 3361 TP and Licowax® E, each available from Clariant of Charlotte, N.C.; and Escorez™ 5320, a tackifying resin commercially available from ExxonMobil of Houston, Tex. In certain other embodiments, these commercially available materials may be used alone or in combination with Oppanol® B12, available from BASF Corporation of Florham Park, N.J.

The amount of component (H) may range from 0.1 to 20%, alternatively 0.5 to 10%, alternatively 1 to 2%, based on the weight of the hot melt adhesive composition.

The Hot Melt compositions of the instant invention can be prepared in several ways.

In one exemplary method, the reactive resin (A) and reactive polymer (B) are premade as described above and then premixed in a high shear mixer via a batch or continuous process and fed into an extruder, such as a twin-screw extruder, for removal of solvents via devolatization. In certain embodiments, the extruded mixture is heated to about 140° C.-180° C. during this devolatization. The extruded and devolatized mixture of the reactive resin (A) and reactive polymer (B) is then cooled to less than 95° C., wherein a mixture of the moisture cure catalyst (C) and the crosslinker (D) are added via a batch or continuous process. In addition, any other combination of optional components (E)-(I) may be also be added via a batch or continuous process. The resultant mixture is then extruded to form the hot melt adhesive, which may be stored for subsequent use or available for immediate application to a substrate. In certain embodiments, for example, the hot melt adhesive may be stored and sealed in a 12 oz aluminum Semco tubes (available from PPG Industries, Semco® Packaging and Application Systems, Pittsburgh, Pa. 15272 USA).

In another exemplary method, the reactive polymer (B) is premade as described above and premixed in a high shear mixer via a batch or continuous process with the alkenyl-functional siloxane resin (component (i) of the reactive resin (A)). To this mixture is added components (ii), (iii), (v) and optional component (iv) (i.e., the remainder of the components of the reactive resin (A)). The resultant mixture is fed into an extruder, such as a twin-screw extruder, for removal of solvents via devolatilization. In certain embodiments, the extruded mixture is heated to about 140° C.-180° C. during this devolatization. The extruded and devolatized mixture is then cooled to less than 95° C., wherein a mixture of the moisture cure catalyst (C) and the crosslinker (D) are added via a batch or continuous process. In addition, any other combination of optional components (E)-(H) may be also be added via a batch or continuous process provided the resulting elastomeric material upon cure is transparent. The resultant mixture is then extruded to form the hot melt adhesive, which may be stored for subsequent use or available for immediate application to a substrate. In certain embodiments, for example, the hot melt adhesive may be stored and sealed in a 12 oz aluminum Semco tubes (available from PPG Industries, Semco® Packaging and Application Systems, Pittsburgh, Pa. 15272 USA).

The hot melt adhesive compositions of the instant invention may be applied to the glass panes as a transparent secondary sealant by any suitable method employed for dispensing organic hot melt formulations. The common factor in these methods is that the composition is heated to a temperature sufficient to induce flow before application. Upon cooling to ambient conditions, the compositions of the present invention are tacky, non-slump adhesive compositions which may be used to bond the glass panes to one another. Alternatively, the bonding can take place while the adhesive is still hot, but the latter will not, of course, support much stress under these conditions. After the desired components are bonded with the hot melt adhesives of the invention, the combination is exposed to ambient air so as to cure the hot melt adhesives to an essentially non-tacky elastomer. Essentially tack-free herein indicates that the surface feels dry or nearly dry to the touch. The time required for completion of this cure process ranges from about a day to more than a month, depending upon the catalyst type, catalyst level, temperature and humidity, inter alia. As a result of this cure, the adhesive strength of the instant compositions is greatly augmented.

The moisture-curable hot melt silicone adhesive compositions of the instant invention show improved creep resistance due to increased reactivity between the resin (A) and the polymer (B). Also, because both the resin (A) and polymer (B) are reactive with each other, the extraction of the reactive resin (A) and reactive polymer (B) after cure is minimized or eliminated.

In a glazing unit according to the present invention, the silicone material employed to provide the seal around the edge of the glass panes is compatible with the spacer and does not derogate from the integrity of the unit and has adequate adhesive properties. These materials may be formulated to have excellent adhesion to glass as well as modulus and elongation characteristics which are particularly appropriate for use as sealants for glazing units.

The present invention also extends to a method of making insulated glazing units as set forth above comprising providing a first pane of glass having a first major surface

Applying a transparent spacer onto the first major surface of the metal frame

Positioning a second glass panel having a first major surface on the transparent spacer

Filling a cavity around the periphery of the glass panels, with transparent silicone adhesive composition, preferably a moisture-curable hot melt silicone adhesive composition as hereinbefore described, said cavity defined by the first major surface of the first glass panel, external surface of transparent spacer and the first major surface of the second glass panel.

Curing the transparent silicone adhesive composition to bond the two glass panels and form an insulated glazing unit.

In one embodiment of the above there is provided a process of making an insulating glass unit comprising the following steps carried out in any desired order namely procuring two glass panes, providing between the two glass panes an endless strip of transparent thermoplastics material in a plastic state applied as a hot melt, optionally containing a dehydrating material, urging the two glass panes towards each other against the thermoplastics material to form a spacer comprising the thermoplastics material adherent to the panes, optionally introducing to the cavity defined by the two panes and the spacer an inert or heavy gas and applying a layer of transparent silicone adhesive composition, preferably a moisture-curable hot melt silicone adhesive composition as hereinbefore described located at the periphery of the unit in contact with external surfaces of the spacer.

If required in an insulating glass unit as hereinbefore described the gas trapped within the unit preferably comprises or consists of SF₆ or an inert gas such as argon, xenon and krypton to improve the level of thermal or acoustic performances achieved. When present, in order to ensure sufficient thermal or acoustic insulation properties, we prefer to ensure that at least 90% of the gas trapped within the unit is argon, xenon, krypton or SF₆ or mixtures thereof.

A glazing unit according to the invention may be constructed in any convenient way. In one method, a hot melt thermoplastic material, optionally containing desiccant, is heated and applied as a hot paste at a temperature in the range of about 120° C. to about 160° C. to the periphery of a cleaned glass pane to form an endless “tape” adjacent to but spaced from the extreme edge of the pane. Whilst the tape is still hot, another cleaned glass pane is pressed against it. Gas may be introduced into the cavity of the unit at a slight over pressure and the panes are pressed together to squeeze the paste into a desired shape having a thickness from about 7 mm to about 10 mm measured in a direction parallel to the plane of the glass pane and continuous contact with each glass pane over an area at least about 6 mm wide around the entire pane, i.e. measured in a direction normal to the plane of the glass pane. The unit is allowed to cool to room temperature and the plastics material hardens to provide the spacer bonded to both panes. Before or after the cooling has been completed a layer of the transparent silicone adhesive composition, preferably a moisture-curable hot melt silicone adhesive composition as hereinbefore described, is extruded into the “U” shaped space defined by the spacer and peripheral portions of the glass panes and allowed to cure to form a seal around the edge of the unit on top of the spacer and adherent to the panes of glass. The layer of the resulting silicone elastomer has a minimum average thickness of 3 mm measured in a direction parallel to the plane of the glass pane and is in continuous contact with each glass pane. Depending on the type of application of the insulating glass unit, a greater thickness of the silicone elastomer may be required. For instance, if the insulating glass unit is to be used in a structural glazing application, the thickness of the silicone elastomer needs to be dimensioned in accordance with national standards and practices or building codes for the use of insulating glass units in structural glazing applications, such as ASTM C 1249-06a(2010) (“Standard Guide for Secondary Seal for Sealed Insulating Glass Units for Structural Sealant Glazing Applications”).

The following Examples, in which the parts and percentages are expressed by weight, illustrate the invention. Examples are to be read with the accompanying drawings in which

FIG. 1 is a diagrammatic section view through an insulating glass unit and

FIG. 2 is a diagrammatic section of an alternative insulating glass unit, both are illustrative of the invention.

The insulating glass unit shown in FIG. 1 was made by procuring a rectangular frame (10) of uniform section formed from hollow, square section of a transparent e.g. glass, tube, which was manufactured by bending all four corners on special bending equipment and joining the spacer frame along one of the longer sections by use of a connection (not shown). The frame may be perforated on the side to be directed to the interior of the unit and desiccant may be housed within the tube. The frame was used to provide a spacer secured to peripheral portions of two glass panes (12) and (14) by means of continuous deposits (16, 18) of a transparent primary sealant material e.g. a polyisobutylene based adhesive composition. A secondary seal (20) was formed around the edge of the unit by extruding the hot melt curable silicone composition as hereinbefore described into the “U” shaped space formed between the edges of the glass panes and the spacer. The composition was allowed to cure to provide the seal. Argon gas was introduced to the cavity (22) between the panes.

Alternatively in FIG. 2, a transparent thermoplastic material containing desiccant was heated and applied as a hot paste at a temperature in the range of about 120° C. to about 160° C. to the periphery of a cleaned glass pane (42) to form an endless “tape” (40) adjacent to but spaced from the extreme edge of the pane. Whilst the tape was still hot, another cleaned glass pane (44) was pressed against it. A gas e.g. argon may be introduced into the cavity (48), if required, typically at a slight over pressure and the panes were pressed together to squeeze the paste into a desired shape having a thickness of about 8 mm measured in a direction parallel to the plane of the glass pane and continuous contact with each glass pane over an area of 12 mm wide around the entire pane i.e. measured in a direction normal to the plane of the glass pane. The unit was allowed to cool to room temperature and the transparent thermoplastic spacer material 40 allowed to harden to provide the spacer bonded to both panes. Before the cooling had been completed a layer of the transparent silicone adhesive composition, preferably a moisture-curable hot melt silicone adhesive composition as hereinbefore described was extruded into the “U” shaped space defined by the spacer and peripheral portions of the glass panes and allowed to cure to form a seal (46) around the edge of the unit on top of the spacer and adherent to the panes of glass. The silicone seal had a thickness of about 3-4 mm measured in a direction parallel to the plane of the glass pane and was in continuous contact with each glass pane.

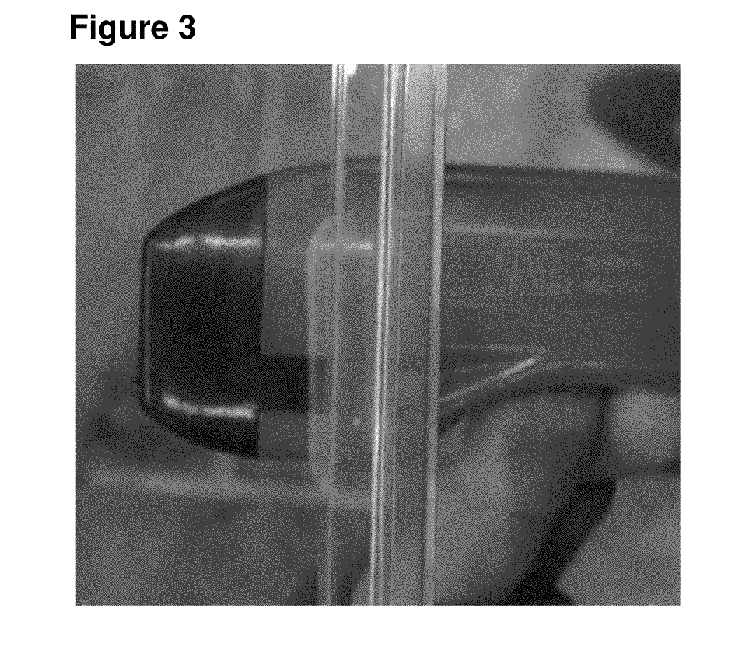

Tests have indicated that the water vapour transmission rate of the hot melt silicone adhesive according to EN 1279-4 gave an average permeability of 14.9 g/24 h·m² on 2 mm thick membranes. An example of an insulating glass unit using a transparent system as hereinbefore described is depicted in FIG. 3.

1. An insulating glass unit comprising:
two glass panes spaced apart by a transparent spacer material adherent to the glass panes;
optionally, an inert or heavy gas trapped within the unit; and
a layer of a transparent silicone elastomer located at the periphery of the unit between edge portions of the glass panes and in contact with external surfaces of the spacer.

2. The insulating glass unit as claimed in claim 1, wherein the spacer is adhered directly to the surface of the glass.

3. The insulating glass unit as claimed in claim 1, wherein the spacer is selected from the group consisting of glass, a hydrosilylation cured silicone rubber elastomer, a peroxide cured silicone rubber elastomer, clear butyl, polymethylmethacrylate (PMMA), polycarbonate, and extruded transparent polyisobutylene (PIB).

4. The insulating glass unit as claimed in claim 1, wherein the spacer is either self-adhesive to the substrate or adhered to the glass using a transparent primary sealant.

5. The insulating glass unit as claimed in claim 1, wherein the silicone elastomer is a cured elastomeric product of a moisture-curable hot melt silicone adhesive composition.

6. The insulating glass unit as claimed in claim 5, wherein the moisture-curable hot melt silicone adhesive composition comprises:
(A) a reactive resin comprising the reaction product of a reaction of:
(i) an alkenyl-functional siloxane resin comprising R₃SiO_{1/2} units and SiO_{4/2} units, wherein each R is independently a monovalent hydrocarbon radical having 1 to 6 carbon atoms with the proviso that at least one R is an alkenyl radical, wherein the molar ratio of the R₃SiO_{1/2} units to SiO_{4/2} units has a value of from 0.5/1 to 1.5/1,
(ii) an alkoxysilane-functional organosiloxane compound having at least one silicon-bonded hydrogen atom, and optionally
(iii) an endcapper, and optionally
(iv) an alkenyltrialkoxysilane, in the presence of a
(v) hydrosilylation catalyst;
(B) a reactive polymer comprising the reaction product of a reaction of:
(vi) an alkoxysilane-functional organosiloxane compound having at least one silicon-bonded hydrogen atom, and
(vii) a polyorganosiloxane having an average, per molecule, of at least two aliphatically unsaturated organic groups, and optionally
(viii) an alkenyltrialkoxysilane, in the presence of
(ix) a hydrosilylation catalyst;
(C) a moisture cure catalyst; and
(D) a crosslinker.

7. A method of making insulated glazing units in accordance with claim 1, the method comprising:
providing a first pane of glass having a first major surface;
applying a transparent spacer onto the first major surface of the first pane;
positioning a second glass pane having a first major surface on the transparent spacer;
filling a cavity around the periphery of the glass panes with a transparent silicone adhesive composition, the cavity defined by the first major surfaces of the two glass panes and external surface of the transparent spacer; and
curing the transparent silicone adhesive composition to bond the two glass panes and form an insulated glazing unit.

8. A method for making an insulating glass unit in accordance with claim 1, the method comprising:
providing between the two glass panes an endless strip of transparent thermoplastics material in a plastic state applied as a hot melt, optionally containing a dehydrating material;
urging the two glass panes towards each other against the thermoplastics material to form a spacer comprising the thermoplastics material adherent to the panes;
optionally, introducing to the cavity defined by the two panes and the spacer an inert or heavy gas; and
applying a layer of transparent silicone adhesive composition at the periphery of the unit in contact with external surfaces of the spacer.

9. The method in accordance with claim 7, wherein the transparent silicone adhesive composition is a moisture-curable hot melt silicone adhesive composition.

10. The method in accordance with claim 9, wherein the moisture-curable hot melt silicone adhesive composition comprises:
(A) a reactive resin comprising the reaction product of a reaction of:
(i) an alkenyl-functional siloxane resin comprising R₃SiO_{1/2} units and SiO_{4/2} units, wherein each R is independently a monovalent hydrocarbon radical having 1 to 6 carbon atoms with the proviso that at least one R is an alkenyl radical, wherein the molar ratio of the R₃SiO_{1/2} units to SiO_{4/2} units has a value of from 0.5/1 to 1.5/1,
(ii) an alkoxysilane-functional organosiloxane compound having at least one silicon-bonded hydrogen atom, and optionally
(iii) an endcapper, and optionally
(iv) an alkenyltrialkoxysilane, in the presence of a
(v) hydrosilylation catalyst;
(B) a reactive polymer comprising the reaction product of a reaction of:
(vi) an alkoxysilane-functional organosiloxane compound having at least one silicon-bonded hydrogen atom, and
(vii) a polyorganosiloxane having an average, per molecule, of at least two aliphatically unsaturated organic groups, and optionally
(viii) an alkenyltrialkoxysilane, in the presence of
(ix) a hydrosilylation catalyst;
(E) a moisture cure catalyst; and
(F) a crosslinker.

11. The insulating glass unit as claimed in claim 1, wherein gas is trapped within the unit and comprises or consists of SF₆ or an inert gas.

12. The method according to claim 7, wherein the silicone elastomer is applied with a minimum average thickness of about 3 mm measured in a direction parallel to the plane of the glass pane and such that it is in continuous contact with each glass pane.

13. The insulating glass unit as claimed in claim 1, wherein the spacer is adhered to the surface of the glass via a transparent primary sealant.

14. The method in accordance with claim 8, wherein the transparent silicone adhesive composition is a moisture-curable hot melt silicone adhesive composition.

15. The method in accordance with claim 14, wherein the moisture-curable hot melt silicone adhesive composition comprises:
(A) a reactive resin comprising the reaction product of a reaction of:
(i) an alkenyl-functional siloxane resin comprising R₃SiO_{1/2} units and SiO_{4/2} units, wherein each R is independently a monovalent hydrocarbon radical having 1 to 6 carbon atoms with the proviso that at least one R is an alkenyl radical, wherein the molar ratio of the R₃SiO_{1/2} units to SiO_{4/2} units has a value of from 0.5/1 to 1.5/1,
(ii) an alkoxysilane-functional organosiloxane compound having at least one silicon-bonded hydrogen atom, and optionally
(iii) an endcapper, and optionally
(iv) an alkenyltrialkoxysilane, in the presence of a
(v) hydrosilylation catalyst;
(B) a reactive polymer comprising the reaction product of a reaction of:
(vi) an alkoxysilane-functional organosiloxane compound having at least one silicon-bonded hydrogen atom, and
(vii) a polyorganosiloxane having an average, per molecule, of at least two aliphatically unsaturated organic groups, and optionally
(viii) an alkenyltrialkoxysilane, in the presence of
(ix) a hydrosilylation catalyst;
(C) a moisture cure catalyst; and
(D) a crosslinker.

16. The method according to claim 8, wherein the silicone elastomer is applied with a minimum average thickness of about 3 mm measured in a direction parallel to the plane of the glass pane and such that it is in continuous contact with each glass pane.
